(19) United States
(12) Patent Application Publication
(10) Pub. No.: US 2023/0093296 A1
(43) Pub. Date: Mar. 23, 2023

(54) WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Toshiya HIROOKA, Yokkaichi-shi (JP); Daisuke HASHIMOTO, Yokkaichi-shi (JP); Ayumu ISHIHARA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 17/909,211

(22) PCT Filed: Mar. 17, 2021
(86) PCT No.: PCT/JP2021/010722

§ 371 Date: Sep. 2, 2022

(30) Foreign Application Priority Data
Mar. 23, 2020 (JP) 2020-050702

(51) Int. Cl. H01B 7/00; H01B 13/012

(52) U.S. Cl. CPC H01B 7/0045; H01B 13/01209

(57) ABSTRACT

A wire harness including: an electric wire; and a tube that surrounds the electric wire, wherein: the electric wire includes: a first electric wire portion including a core wire and an insulating cover that covers the core wire, and a second electric wire portion connected to a lengthwise end of the core wire, the second electric wire portion includes a flexible portion having a higher flexibility than the first electric wire portion, the flexible portion includes a bend that is bent so as to protrude in a direction orthogonal to a length direction of the second electric wire portion, and the bend is provided outside of the tube.

### BACKGROUND

The present disclosure relates to a wire harness.

As one example, a wire harness for a vehicle described in JP 2005-44607A includes an electric wire for electrically connecting a pair of mating components to each other, and a tubular exterior member that surrounds the electric wire. A flexible wire such as a stranded wire is used as the electric wire. Also, a clearance is set between the electric wire and the inner surface of the exterior member, and the electric wire is allowed to bend inside the exterior member. In this wire harness, the length of the electric wire is set such that electrical connection is possible even if the positional tolerance of the pair of mating components is at the maximum value. The positional tolerance of the mating components is absorbed by bending of the electric wire inside the exterior member.

### SUMMARY

With a wire harness such as that described above, a clearance for absorbing tolerance needs to be set between the electric wire and the inner surface of the exterior member, and thus there is room for improvement in terms of reducing the size of the exterior member.

An exemplary aspect of the disclosure provides a wire harness that enables a reduction in the size of the exterior member.

A wire harness according to an aspect of the present disclosure includes: an electric wire; and a tube that surrounds the electric wire, wherein the electric wire includes: a first electric wire portion including a core wire and an insulating cover that covers the core wire, and a second electric wire portion connected to a lengthwise end of the core wire, the second electric wire portion includes a flexible portion having a higher flexibility than the first electric wire portion, the flexible portion includes a bend that is bent so as to protrude in a direction orthogonal to a length direction of the second electric wire portion, and the bend is provided outside of the tube.

According to the present disclosure, it is possible to provide a wire harness that enables a reduction in the size of the tube.

### BRIEF DESCRIPTION OF THE DRAWINGS

FIG. 1 is a schematic cross-sectional view schematically showing a wire harness according to an embodiment.

FIG. 2 is a schematic cross-sectional view for describing a mode of manufacturing the wire harness according to the embodiment.

### DETAILED DESCRIPTION OF EMBODIMENTS

### Description of Embodiments of Present Disclosure

First, embodiments of the present disclosure will be listed and described.

A wire harness according to an aspect of the present disclosure is:

[1] A wire harness including: an electric wire; and a tubular exterior member surrounding the electric wire, wherein the electric wire includes: a first electric wire portion including a core wire and an insulating covering that covers the core wire, and a second electric wire portion connected to a lengthwise end portion of the core wire, the second electric wire portion includes a flexible portion having a higher flexibility than the first electric wire portion, the flexible portion includes a bent portion that is bent so as to protrude in a direction orthogonal to a length direction of the second electric wire portion, and the bent portion is provided outside of the exterior member.

According to this configuration, positional tolerance of a mating component to which the electric wire is to be connected can be absorbed by the bending of the bent portion of the flexible portion provided outside of the exterior member. Accordingly, a clearance for absorbing tolerance does not need to be set between the first electric wire portion and the inner surface of the exterior member (or even if a clearance is set, the clearance can be set small), thus making it possible to reduce the size of the exterior member in a direction orthogonal to the electric wire insertion direction.

[2] A configuration is possible in which the second electric wire portion is constituted by a plurality of strands, and the bent portion is formed in a bent shape by press working. According to this configuration, it is possible to suitably form the flexible portion that includes the bent portion.

[3] A configuration is possible in which the second electric wire portion includes a hardened portion having a higher rigidity than the flexible portion due to the plurality of strands being joined to each other in the hardened portion, and the hardened portion is a portion configured to be connected to a mating component, in the second electric wire portion.

According to this configuration, the second electric wire portion, which is constituted by a plurality of strands, does not need to be separately provided with a metal terminal or the like for connection with the mating component, thus making it possible to suppress an increase in the number of components of the wire harness.

[4] A configuration is possible in which the second electric wire portion includes a first hardened portion that is the hardened portion, and a second hardened portion having a higher rigidity than the flexible portion due to the plurality of strands being joined to each other in the second hardened portion, and the second hardened portion is connected to the lengthwise end portion of the core wire in the first electric wire portion. According to this configuration, the first electric wire portion and the second electric wire portion can be suitably connected at the second hardened portion of the second electric wire portion.

[5] A configuration is possible in which the second hardened portion is located circumferentially inward of a lengthwise end surface of the exterior member.

According to this configuration, the bent portion of the flexible portion can be suitably arranged outside of the exterior member.

[6] A configuration is possible in which the first electric wire portion and the second electric wire portion are components that are separate from each other.

According to this configuration, the flexible portion of the second electric wire portion can be suitably configured.

### Details of Embodiments of Present Disclosure

A specific example of a wire harness according to the present disclosure will be described below with reference to the drawings. In the drawings, some configurations may be exaggerated or simplified for convenience in the description. Also, the dimensional ratios of portions may differ among the drawings. Moreover, the terms “parallel” and “orthogonal” in the present specification include not only the case of being strictly parallel or orthogonal, but also the case of being substantially parallel or substantially orthogonal to the extent that actions and effects in the embodiment are exhibited. It should be noted that the present disclosure is not limited to the examples herein, but rather is indicated by the scope of claims, and is intended to include all modifications within a meaning and scope equivalent to the scope of claims.

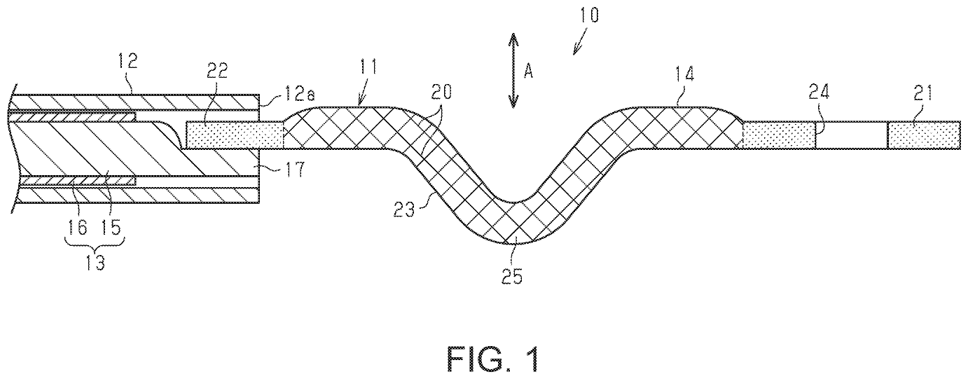

A wire harness 10 shown in FIG. 1 is a wire harness used for electrical connection in a battery module (not shown) in a hybrid vehicle, an electric automobile, or the like.

The wire harness 10 includes an electric wire 11 and a tubular exterior member 12 (tube) that surrounds the electric wire 11, specifically a portion thereof in the length direction of the electric wire 11.

Configuration of exterior member 12

The exterior member 12 is overall shaped as an elongated tube. Note that the shape of a cross-section of the exterior member 12 taken in a direction orthogonal to the length direction (i.e., the transverse sectional shape) can be any shape such as the shape of a circular tube, an elliptical tube, or a polygonal tube. The electric wire 11 is inserted into an internal space inside the exterior member 12.

Note that the term “tubular” in the present specification need only refer to a shape that appears to be tubular overall, and encompasses a tubular shape that is a combination of multiple components, a tubular shape partially having a notch as with a C-shape, or the like. The exterior member 12 of the present embodiment is constituted by one component.

The exterior member 12 of the present embodiment is configured as a shield protector for preventing electromagnetic noise emitted by the electric wire 11 from leaking to the outside, for example. In the case of serving as a shield protector, the exterior member 12 is formed from a conductor such as a metal. The shield protector can be formed from a metal material such as copper-based or aluminum-based material.

Overall configuration of electric wire 11

The electric wire 11 includes a first electric wire portion 13 and a second electric wire portion 14. The first electric wire portion 13 and the second electric wire portion 14 are arranged side-by-side in the length direction of the electric wire 11.

Configuration of first electric wire portion 13

The first electric wire portion 13 includes a core wire 15 and an insulating covering 16 (insulating cover) that covers the core wire 15.

The core wire 15 of the first electric wire portion 13 is formed with a higher rigidity than the second electric wire portion 14. The core wire 15 of the present embodiment may be a columnar conductor made of one columnar metal rod having a solid internal structure, or a tubular conductor made of a tubular metal pipe having a hollow internal structure, for example. Note that examples of a columnar conductor include a single core wire and a bus bar.

Also, the core wire 15 may be made of a metal material such as copper-based or aluminum-based material, for example. Note that the shape of a cross-section of the core wire 15 taken in a direction orthogonal to the length direction (i.e., the transverse sectional shape) can be any shape such as the shape of a circle, a semi-circle, a polygon, or a flattened shape.

One end portion of the core wire 15 in the length direction is provided with a connection portion 17 formed by squashing the end portion in a direction orthogonal to the length direction of the core wire 15 to form a substantially flat plate.

The insulating covering 16 that covers the outer peripheral surface of the core wire 15 is for electrically insulating the core wire 15 from the outside over substantially the entire length direction of the core wire 15. The insulating covering 16 is an enamel covering, which is more suited to a size reduction than an insulating covering made of a synthetic resin, for example. Note that a configuration is possible in which the connection portion 17 of the core wire 15 is not covered by the insulating covering 16.

Configuration of second electric wire portion 14

The second electric wire portion 14 of the electric wire 11 has a linear shape. The second electric wire portion 14 is connected to the connection portion 17 of the core wire 15. The flexibility of a portion of the second electric wire portion 14 in the length direction is set higher than that of the first electric wire portion 13.

The second electric wire portion 14 is constituted by a plurality of strands 20 and has flexibility, for example. The second electric wire portion 14 can be constituted by a braided wire in which a plurality of strands 20 are woven, or a stranded wire in which a plurality of strands 20 are twisted, for example. The strands 20 can be formed using a metal material such as a copper-based or aluminum-based material, for example.

As described above, the second electric wire portion 14, which is constituted by a plurality of strands 20, includes a first connection portion 21 for connection to a mating component that is not shown (such as a terminal on the battery module side in the present embodiment), a second connection portion 22 for connection to the connection portion 17 of the core wire 15, and a flexible portion 23 that connects the first connection portion 21 and the second connection portion 22. The first connection portion 21 and the second connection portion 22 are respectively formed at the two end portions of the second electric wire portion 14 in the length direction.

Configuration of first connection portion 21

The first connection portion 21 is a hardened portion (first hardened portion) formed by joining the strands 20 to each other so as to have a higher rigidity than the flexible portion 23. In the first connection portion 21, the strands 20 are joined (integrated) to each other by ultrasonic welding or resistance welding, for example. The first connection portion 21 is shaped as a substantially flat plate that is squashed in a direction orthogonal to the length direction of the second electric wire portion 14.

The first connection portion 21 is provided with a through hole 24 that extends through the first connection portion 21 in the plate thickness direction. A bolt (not shown) for fixing to the mating component is inserted into the through hole 24. The first connection portion 21 is fixed to the mating component by screwing the bolt. Due to joining the strands 20 together so as to be hardened as described above, the first connection portion 21 has a rigidity that can withstand fastening and fixing with the bolt (a rigidity according to which damage or deformation does not occur).

Configuration of second connection portion 22

The second connection portion 22 is a hardened portion (second hardened portion) formed by joining the strands 20 to each other so as to have a higher rigidity than the flexible portion 23. In the second connection portion 22, the strands 20 are joined (integrated) to each other by ultrasonic welding or resistance welding, for example. The second connection portion 22 is shaped as a substantially flat plate that is squashed in a direction orthogonal to the length direction of the second electric wire portion 14. Note that the second connection portion 22 is fixed to the connection portion 17 of the core wire 15 by ultrasonic welding, resistance welding, or the like. When the second connection portion 22 and the connection portion 17 are fixed to each other, the strands 20 in the second connection portion 22 are joined to each other.

Configuration of flexible portion 23

The flexible portion 23 is formed between the first connection portion 21 and the second connection portion 22. In the flexible portion 23, unlike the first connection portion 21 and the second connection portion 22, hardening by joining the strands 20 is not performed, and flexibility is maintained in the braided wire or the stranded wire constituted by the strands 20. Accordingly, the flexible portion 23 has higher flexibility than the first connection portion 21, the second connection portion 22, and the first electric wire portion 13.

The flexible portion 23 includes a bent portion 25 (bend) that has a bent shape formed by press working, which will be described later. The bent portion 25 is bent in a substantially U-like shape that protrudes in a direction (direction A in FIG. 1) orthogonal to the length direction of the second electric wire portion 14 (direction along a straight line connecting the first connection portion 21 and the second connection portion 22). Note that in the present embodiment, the length direction of the second electric wire portion 14 is substantially parallel to the length direction of the first electric wire portion 13. The bent portion 25 of the present embodiment protrudes in only one direction along the direction A, for example.

In the electric wire 11 having the above configuration, the first electric wire portion 13 is arranged inside the exterior member 12. On the other hand, the bent portion 25 and the first connection portion 21 of the second electric wire portion 14 are provided outside of the exterior member 12. The second connection portion 22 of the second electric wire portion 14 is located circumferentially inward of a lengthwise end surface 12a of the exterior member 12, for example. In other words, the end surface 12a of the exterior member 12 and the second connection portion 22 are arranged at the same position as each other in the length direction of the electric wire 11. Also, in the second connection portion 22, a portion of the second connection portion 22 is located inside the exterior member 12, and a portion of the second connection portion 22 is located outside of the exterior member 12, for example. Also, the end portion of the bent portion 25 in the direction A protrudes outward beyond the outer surface of the exterior member 12, for example.

Next, a mode of manufacturing the electric wire 11 will be described.

First, the second connection portion 22 of the second electric wire portion 14 is fixed to the connection portion 17 of the core wire 15 by ultrasonic welding or resistance welding, for example, as described above. At this time, the strands 20 constituting the second connection portion 22 are joined to each other.

Next, as described above, the first connection portion 21 is formed by joining and hardening the strands 20 that constitute the second electric wire portion 14 by ultrasonic welding or resistance welding, for example. Also, due to the hardening of the first connection portion 21 and the second connection portion 22, the flexible portion 23 is formed between the first connection portion 21 and the second connection portion 22.

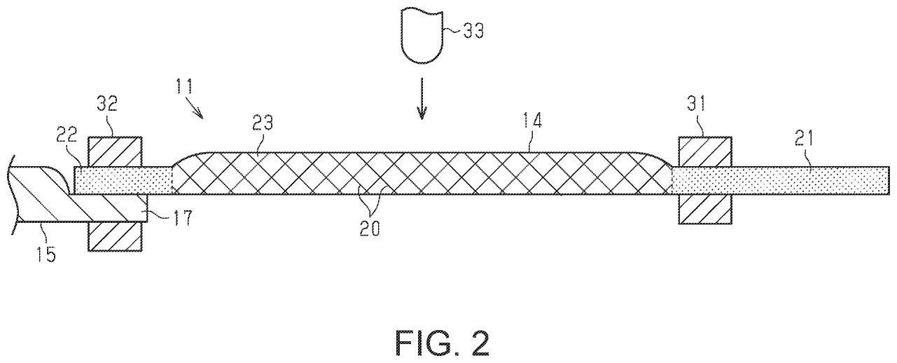

Next, as shown in FIG. 2, the first connection portion 21 is placed in a first holding jig 31. Also, the second connection portion 22 and the connection portion 17, which are fixed to each other, are placed in a second holding jig 32. Also, the flexible portion 23 is pulled straight while holding the first connection portion 21 and the second connection portion 22. Note that at this point, the through hole 24 has not yet been formed in the first connection portion 21.

Subsequently, the bent portion 25 is formed in the flexible portion 23 by performing press working with use of a pressing jig 33. At this time, the pressing jig 33 is used to press the straight flexible portion 23 from a direction orthogonal to the length direction of the flexible portion 23. Also, at the same time as the flexible portion 23 is pressed by the pressing jig 33, at least either the first holding jig 31 holding the first connection portion 21 or the second holding jig 32 holding the second connection portion 22 and the connection portion 17 is moved closer to the other one. Accordingly, the bent portion 25 is formed having a bent shape protruding in the direction A, which is orthogonal to the length direction of the second electric wire portion 14.

Actions of the present embodiment will be described below.

The bent portion 25 provided outside of the exterior member 12 has a bent shape protruding in the direction A orthogonal to the length direction of the second electric wire portion 14, and thus the bent portion 25 can easily bend mainly in the length direction of the second electric wire portion 14. Therefore, positional tolerance of mating components connected to the end portions of the electric wire 11 in the length direction is absorbed by the bending of the bent portion 25. Also, due to the bending of the bent portion 25, it is possible to also absorb positional deviation of a mating component or the like caused by thermal expansion.

Effects of the present embodiment will be described below.

(1) The first electric wire portion 13 is arranged inside the exterior member 12, and the bent portion 25 of the flexible portion 23 is provided outside of the exterior member 12. According to this configuration, positional tolerance of a mating component (not shown) to which the electric wire 11 is to be connected can be absorbed by the bending of the bent portion 25 of the flexible portion 23 provided outside of the exterior member 12. Accordingly, a clearance for absorbing tolerance does not need to be set between the first electric wire portion 13 and the inner surface of the exterior member 12, thus making it possible to reduce the size of the exterior member 12 in the direction orthogonal to the insertion direction of the electric wire 11 (direction along the direction A).

(2) The second electric wire portion 14 is constituted by a plurality of strands 20. The bent portion 25 of the flexible portion 23 is formed in a bent shape by press working. According to this configuration, it is possible to suitably form the flexible portion 23 that includes the bent portion 25.

(3) The second electric wire portion 14 includes the first connection portion 21 (first hardened portion) having a higher rigidity than the flexible portion 23 due to the strands 20 being joined to each other. The first connection portion 21 is a portion of the second electric wire portion 14 for connection with a mating component (not shown). According to this configuration, it is not necessary to separately provide the second electric wire portion 14 with a metal terminal or the like for connection with the mating component, thus making it possible to suppress an increase in the number of components of the wire harness 10.

(4) The second electric wire portion 14 includes the second connection portion 22 (second hardened portion) having a higher rigidity than the flexible portion 23 due to the strands 20 being joined to each other. The second connection portion 22 is connected to the connection portion 17 provided at the lengthwise end portion of the core wire 15. According to this configuration, the first electric wire portion 13 and the second electric wire portion can be suitably connected by the second connection portion 22, which is the second hardened portion.

(5) The second connection portion 22 is located circumferentially inward of the lengthwise end surface 12a of the exterior member 12. According to this configuration, the bent portion 25 of the flexible portion 23 can be suitably arranged outside of the exterior member 12. If the second connection portion 22 is located circumferentially inward of the end surface 12a of the exterior member 12, the opening edge of the exterior member 12 frequently comes into contact with the second connection portion 22. However, due to the strands 20 being joined to each other to harden the second connection portion 22, it is possible to prevent or suppress breakage of the strands 20 of the second connection portion 22 caused by the opening edge of the exterior member 12.

(6) The first electric wire portion 13 and the second electric wire portion 14 are components that are separate from each other, and therefore the flexible portion 23 of the second electric wire portion 14 can be suitably configured.

The present embodiment can be implemented with modifications such as the following. The present embodiment and the following modified examples can be implemented in combination with each other as long as no technical contradiction arises.

The second connection portion 22 may be entirely arranged inside the exterior member 12 or outside of the exterior member 12.

The first connection portion 21 may be constituted by a metal terminal that is separate from the second electric wire portion 14.

The second electric wire portion 14 is not limited to being formed by the materials described in the above embodiment, and may be constituted by a conductive member other than a braided wire or stranded wire constituted by a plurality of strands 20, as long as it is a conductive member that is more flexible (bendable) than the first electric wire portion 13.

In the above embodiment, the first connection portion 21 is formed after connection of the second connection portion 22 to the connection portion 17, but the present disclosure is not particularly limited to this. Specifically, the second connection portion 22 and the connection portion 17 may be connected after the first connection portion 21 is formed, or the first connection portion 21 may be formed at the same time as the second connection portion 22 and the connection portion 17 are connected.

The bent shape of the bent portion 25 is not limited to being a substantially U-like shape protruding in only one direction along the direction A, and can be changed to, for example, a substantially V-like shape. As another example, the bent portion 25 may be bent in a wavy shape when viewed from a direction orthogonal to the length direction of the second electric wire portion 14.

The braided wire constituting the second electric wire portion 14 may be a braided wire formed by combining metal strands and resin strands, for example. For example, the resin strands can be reinforcing fibers that have excellent insulating properties and shear resistance, such as para-aramid fibers.

In the above embodiment, the entirety of the first electric wire portion 13 in the length direction is arranged inside the exterior member 12, but the present disclosure is not limited to this, and a portion of the first electric wire portion 13 in the length direction may be located outside of the exterior member 12, for example.

The insulating covering 16 in the above embodiment may be changed to an insulating covering made of a synthetic resin.

The core wire 15 in the first electric wire portion 13 can be a stranded wire formed by twisting a plurality of metal strands, for example. Also, the core wire 15 may be constituted by a combination of a stranded wire and a columnar conductor or a tubular conductor, for example.

The exterior member 12 may be formed from a resin material. The resin exterior member 12 can be formed using a synthetic resin such as polyolefin, polyamide, polyester, or ABS resin.

In the above embodiment, the present disclosure is applied to the wire harness 10 used for electrical connection of a battery module, but the present disclosure is not limited to this, and may be applied to a wire harness used for electrical connection of an in-vehicle device other than a battery module.

As shown in FIG. 1, a portion or all of the bent portion 25 of the second electric wire portion 14 in the above embodiment may be arranged outside of the opening end of the exterior member 12 in the lengthwise direction of the exterior member 12.

As shown in FIG. 1, in the standalone state of the wire harness 10, before the wire harness 10 is connected to the mating component, the second electric wire portion 14 may be bent in advance such that at least a portion of the bent portion 25 is outward of the outermost surface of the exterior member 12 in the diameter direction of the exterior member 12, for example.

The first connection portion 21 in the above embodiment may be referred to as the leading end of the second electric wire portion 14 or a first length portion of the second electric wire portion 14. The second connection portion 22 of the embodiment may be referred to as the base end of the second electric wire portion 14 or a second length portion of the second electric wire portion 14. The flexible portion 23 in the above embodiment may be referred to as an intermediate portion between the leading end and the base end of the second electric wire portion 14, or a third length portion of the second electric wire portion 14.

The first connection portion 21 of the second electric wire portion 14 in the above embodiment may be referred to as a first joined strand block in which a plurality of conductive strands 20 are compressed and joined over a first length so as to be immovable relative to each other. The second connection portion 22 of the second electric wire portion 14 in the above embodiment may be referred to as a second joined strand block in which a plurality of conductive strands 20 are compressed and joined over a second length so as to be immovable relative to each other. The flexible portion 23 of the second electric wire portion 14 in the above embodiment may be referred to as a bundle or unjoined portion of conductive strands 20, in which a plurality of conductive strands 20 are movable relative to each other and are not joined to each other.

In the second electric wire portion 14 in the above embodiment, the volume percentage of voids in the first connection portion 21 per unit volume of the first connection portion 21 may be referred to as the first void rate. The volume percentage of voids in the second connection portion 22 per unit volume of the second connection portion 22 may be referred to as the second void rate. The volume percentage of voids in the flexible portion 23 per unit volume of the flexible portion 23 may be referred to as the third void rate. The first void rate may be the same as or different from the second void rate. The first void rate and/or the second void rate may be smaller than the third void rate. In other words, in the embodiment, the conductor volume percentage of the flexible portion 23, which is the percentage of the volume of the conductor per unit volume of the flexible portion 23, may be lower than the conductor volume percentage of the first connection portion 21, and/or lower than the conductor volume percentage of the second connection portion 22.

As shown in the illustrated example, the second electric wire portion 14, which includes the first connection portion 21 and the second connection portion 22, may be a braided member that extends seamlessly and continuously from the first connection portion 21 to the second connection portion 22, and that includes the conductive strands 20 or is constituted by only the conductive strands 20.

The entirety of the first connection portion 21 and/or the entirety of the second connection portion 22 in the above embodiment may be constituted by only the strands 20.

1. A wire harness comprising:
an electric wire; and
a tube that surrounds the electric wire, wherein:
the electric wire includes:
a first electric wire portion including a core wire and an insulating cover that covers the core wire, and
a second electric wire portion connected to a lengthwise end of the core wire,
the second electric wire portion includes a flexible portion having a higher flexibility than the first electric wire portion,
the flexible portion includes a bend that is bent so as to protrude in a direction orthogonal to a length direction of the second electric wire portion, and
the bend is provided outside of the tube.

2. The wire harness according to claim 1, wherein:
the second electric wire portion is formed by a plurality of strands, and
the bend is formed in a bent shape by press working.

3. The wire harness according to claim 2, wherein:
the second electric wire portion includes a hardened portion having a higher rigidity than the flexible portion due to the plurality of strands being joined to each other in the hardened portion, and
the hardened portion is a portion configured to be connected to a mating component in the second electric wire portion.

4. The wire harness according to claim 3, wherein:
the hardened portion is a first hardened portion and the second electric wire portion further includes a second hardened portion having a higher rigidity than the flexible portion due to the plurality of strands being joined to each other in the second hardened portion, and
the second hardened portion is connected to the lengthwise end of the core wire in the first electric wire portion.

5. The wire harness according to claim 4,
wherein the second hardened portion is located circumferentially inward of a lengthwise end surface of the tube.

6. The wire harness according to claim 1,
wherein the first electric wire portion and the second electric wire portion are components that are separate from each other.
